(19) United States
(12) Patent Application Publication
(10) Pub. No.: US 2016/0019624 A1
(43) Pub. Date: Jan. 21, 2016

(54) COMPUTER PROGRAM FOR GUIDING THE PURCHASE OF CLOTHING ARTICLES

(71) Applicants: Sarah McBryer, Silver Lake, OH (US); Shon Christy, Stow, OH (US)

(72) Inventors: Sarah McBryer, Silver Lake, OH (US); Shon Christy, Stow, OH (US)

(21) Appl. No.: 14/803,195

(22) Filed: Jul. 20, 2015

Related U.S. Application Data
(60) Provisional application No. 62/026,611, filed on Jul. 19, 2014.

(51) Int. Cl. G06Q 30/06

(52) U.S. Cl. CPC G06Q 30/0627; G06Q 30/0631; G06Q 30/0641

(57) ABSTRACT

A computer program for guiding the purchase of clothing articles may include a user profile. The user profile may comprise a data entry interface adapted to receive user preference data such as clothing sizing parameters, color preferences, and/or style preferences. The user profile may also include a sharing feature enabling a user to share preferences with other users. The computer program may also include a manufacturer sizing database containing clothing article dimensions. Furthermore, the computer program may include an article recommendation feature adapted to apply a recommendation algorithm to user preferences and to a plurality of purchase options so as to arrive at a set of recommended articles.

### I. BACKGROUND OF THE INVENTION

A. Field of Invention

Embodiments generally relate to computer programs for online shopping.

B. Description of the Related Art

Systems and method are known for recommending purchases to online shoppers. Online clothing purchases are particularly challenging because buyers are limited in the ways that they can interact with an article to determine whether it would fit and whether it would look or feel appealing when worn. This problem is further complicated by inconsistencies in sizing parameters from one manufacturer to the next. For instance, the common sizes small, medium, and large can comprise entirely different dimensions from manufacturer to manufacturer. Accordingly, it is difficult to predict how a piece will actually fit. The negative effects of this problem may be partially mitigated with a liberal returns policy; however, returns impose significant expense on online retailers and can significantly impact profit margins. What is needed is a way to accurately predict how an online article will fit in spite of sizing inconsistencies.

Some embodiments of the present invention may provide one or more benefits or advantages over the prior art.

### II. SUMMARY OF THE INVENTION

Some embodiments may relate to a computer program for guiding the purchase of clothing articles, comprising: a user profile comprising (i) a data entry interface adapted to receive user preference data including clothing article sizing parameters, clothing article color preferences, and clothing article style preferences; (ii) a sharing feature enabling a user to share user preference data with other user-selected users; a manufacturer sizing database stored on a computer readable medium and containing clothing article dimensions; and an article recommendation feature adapted to apply a recommendation algorithm to user preference data and to a plurality of purchase options to arrive at a set of articles recommended based at least on size, and one or more of color, style, or article type.

Embodiments may also include a manufacturer sizing chart database stored on a computer readable medium and containing two dimensional printable 1:1 scale images which may be compared to a portion of a user's body to select an appropriately sized article.

Embodiments may also include an auto fill tool adapted to read shared user preference data from a user profile of another to auto fill fields in an e-commerce website.

In some embodiments the auto fill tool is further adapted to read shared user sizing data from a user profile of another into one or more fields of an e-commerce website while concealing the sizing data from view.

In some embodiments articles recommended by the article recommendation feature are selected from one or more of clothing, jewelry, makeup, or shoes.

Embodiments may also include comprising a GPS locator tool adapted to determine the location of a user's GPS enabled device and pass the location data to the article recommendation engine.

Embodiments may also include comprising a tag scanning tool adapted to read photographic barcode data from a product tag, match the barcode data to a particular product, and add the product to a user's wish list.

Embodiments may also relate to a computer program for guiding the purchase of clothing articles, comprising: a user profile comprising (i) a data entry interface adapted to receive user preference data including clothing article sizing parameters, clothing article color preferences, and clothing article style preferences; (ii) a sharing feature enabling a user to share user preference data with other user-selected users; a manufacturer sizing database stored on a computer readable medium and containing clothing article dimensions; and a manufacturer sizing chart database stored on a computer readable medium and containing two dimensional printable 1:1 scale images which may be compared to a portion of a user's body to select an appropriately sized article.

Embodiments may also relate to a computer program for guiding the purchase of clothing articles, comprising: a user profile comprising (i) a data entry interface adapted to receive user preference data including clothing article sizing parameters, clothing article color preferences, and clothing article style preferences; (ii) a sharing feature enabling a user to share user preference data with other user-selected users; a manufacturer sizing database stored on a computer readable medium and containing clothing article dimensions; and an auto fill tool adapted to read shared user preference data from a user profile of another to auto fill fields in an e-commerce website.

In some embodiments the auto fill tool is further adapted to read shared user sizing data from a user profile of another into one or more fields of an e-commerce website while concealing the sizing data from view.

Other benefits and advantages will become apparent to those skilled in the art to which it pertains upon reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a conceptual diagram showing selected features of an embodiment;

FIG. 2 is a conceptual diagram illustrating several elements of a generic user profile;

FIG. 3A is a schematic diagram illustrating a method for making recommendations to a user;

FIG. 3B is a schematic diagram illustrating a method for making recommendations to a friend;

FIG. 4 is a schematic diagram illustrating a method for sharing data with a friend for the purpose of making a purchasing decision in an online store;

FIG. 5A illustrates how some data may be shared while being obscured from view;

FIG. 5B the article of FIG. 5A in an ecommerce shopping cart with the size obscured; and

FIG. 6 illustrates a 1:1 scale printable sizing chart.

### IV. DETAILED DESCRIPTION OF THE INVENTION

Embodiments may comprise a computer program, system, and/or related methods for guiding a user through an on-line purchase of articles of clothing, jewelry, makeup, or any of a wide variety of other products where personal preferences enter into the purchasing decision. In general, a user may share its preferences with other users and friends thereby enabling the other users and friends to make purchases for the user according to his/her individual tastes. Embodiments relieve users of the need to remember, or ever know, the personal tastes and preferences of multiple persons for whom they buy gifts. Thus, embodiments may dramatically reduce gift returns, for instance, due to buying an article of clothing having the wrong size or having characteristics such as color or style that the receiver of the gift would find undesirable.

Embodiments may include a plurality of user profiles. Each user profile may include a user interface which enables a user to enter personal information defining its requirements and preferences including, without limitation, color, pattern, style, material, cut, and/or size. For instance, a user may enter body measurements so that the embodiment can apply sizing algorithms to the measurements to determine which size of a particular article of clothing or shoe, for instance, would provide a good fit. Accordingly, embodiments obviate the need to actually try on the article. Determining a proper size in online shopping is an especially complex problem because the typical letter sizes (S, M, L, XL, etc.) for clothing do not directly or even predictably translate into specific dimensions. Thus, an embodiment may contain dimensional data for each article from each manufacturer, so that the embodiment can determine, for example, that a user having a particular shoulder span, torso length, arm length, and neck circumference would fit a size “L” of a Brand X men's shirt. If the user has also indicated a preference for certain colors, patterns, and/or styles then the embodiment may recommend products that will fit the user, and that the user will likely find appealing.

Embodiments may provide users with features for sharing one or more elements of their profile with other users, or even with non-users, of the embodiment. For example, a first user may share its preferences with respect to clothing, shoes, makeup, jewelry, and/or accessories with a second user. The first user may also share its body measurements. According to some embodiments, shared data may be viewable by the second user with whom it is shared; however, some data may be obscured. For example, the first user may allow others to view color and style preferences, but may wish to obscure body dimensions for reasons of modesty. Regardless of whether the shared information is viewable or obscured, the backend of an embodiment may guide the purchasing decision of the second user with whom the data was shared by only suggesting products that satisfy the first user's preferences and sizing requirements. Accordingly, the second user can purchase a clothing gift for the first user without having to have personal knowledge of the first user's body dimensions.

Embodiments may also include one or more databases of manufacturers' product dimensions. For example, such a database may include sufficient physical dimensions of shoes and/or clothing so that the dimensions can be compared to the body dimensions of a user to select an appropriate size. One skilled in the art may vary from one product or class of product to another. For instance, a database record of an athletic running shoes may include a length measured from the base of the heel to the tip of the large toe, a width measured at the widest point in the forefoot, and may optionally include a measure of arch support ranging from extreme pronation to extreme supination. However, arch support may not necessarily be accounted for in dress shoes which typically do not include such features. Thus, an embodiment may compare the dimensions of a user's foot to the dimensions of various shoes to automatically select or recommend an appropriate shoe size of a particular shoe model from a particular manufacturer.

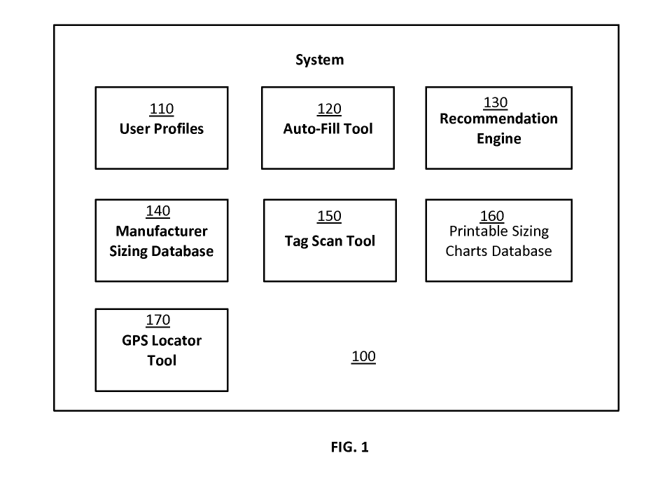

Referring now to the drawings wherein the showings are for purposes of illustrating embodiments of the invention only and not for purposes of limiting the same, FIG. 1 is a schematic drawing of a system 100 according to one embodiment. The system includes a set of user profiles 110, an auto fill tool 120, a recommendation engine 130, a manufacturer sizing database 140, a tag scan tool 150, a printable sizing chart database 160, and a GPS locator tool 170. The foregoing elements of a system 100 cooperate and communicate with each other to present users with product recommendations according to a specific user's body dimensions, and personal taste preferences, location, and the user's wish list. A tag scan tool 150 may operate by enabling a user to take a photo of an item's bar-coded tag using the user's smart phone, matching the barcode to a particular product, and adding the product to the user's wish list within the user's profile. The GPS locator 170 may operate by accessing the GPS features of the user's smart phone to determine the user's location, and then correlating the user's location to the locations of stores having products recommended for the user, or for friends of the user for whom he/she may wish to purchase a gift.

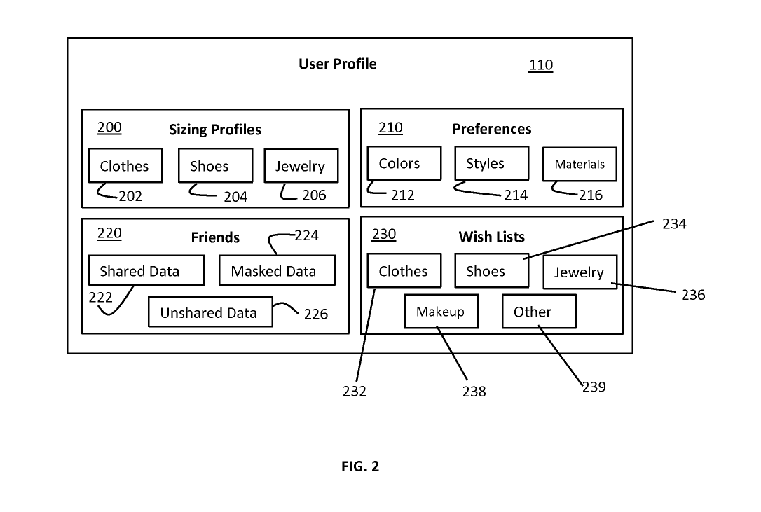

FIG. 2 illustrates several elements of a generic user profile 110. The profile 110 includes a set of sizing profiles 200. For instance, in this example we have sizing profiles for clothes 202, shoes 204, and for jewelry 206. Each of these profiles may contain body dimensions and/or may contain sub-profiles for particular kinds of clothing, shoes, or jewelry. For example a different set of body dimensions would be relevant to shirts as opposed to pants, or rings as opposed to bracelets.

The profile 110 of FIG. 2 also includes a set of user preferences including colors 212, styles 214, and materials 216. On skilled in the art will appreciate that this list is for purposes of illustrating the underlying principles rather than limiting the invention in any way. With regard to colors, a user's color preference may be subdivided according to the kind of article. For example, a user may like blue for shirts, but not for shoes. Similarly, the style 214 preferences of a user may be broken down by the kind of article, e.g. men's dress shirts may include a variety of style elements including the cut of the collar, cuffs, breast pocket, and so on. Similar sets of style parameters may be provided for shoes, pants, dresses, neck ties, shorts, and so on.

A friends 220 portion of the user profile 110 of FIG. 2 includes tools for controlling the sharing of data with other users. For instance, a friend tool may allow a user to connect to, or “friend”, other users. A shared data tool 222 may allow a user to select data for sharing with friends, and may also include tools for restricting data sharing according to one or more classes of friends. For example, a first class may have access to all sharable data, and a second class may be restricted to a curtained predefined subset thereof. A masking tool 224 may be provided which allows a user to share certain data such as body dimensions, without allowing the person with whom it is being shared to actually view the data. Thus, masked data would still be used by the embodiments to recommend appropriately sized articles to a friend but the user's body dimensions and/or the size of the article being purchased may be obscured from view or not displayed at all.

With further regard to FIG. 2 an unshared data tool 226 may be provided for unsharing certain data. For example, a user may by default share all of its data with friends, but may later decide that it would prefer to keep some data, such as body dimensions, private. The unsharing tool 226 would be used to select and restrict such data. Finally, FIG. 2 includes several wish lists 230 broken down by article type. These lists may be created by a user in the course of online window shopping wherein the user selects items that it may wish to buy some time in the future, or that it would like to indicate as an appropriate or desirable gift option. As shown in FIG. 2, wish lists may include lists of clothes 232, shoes 234, jewelry 236, makeup 238 or any other class of items 239.

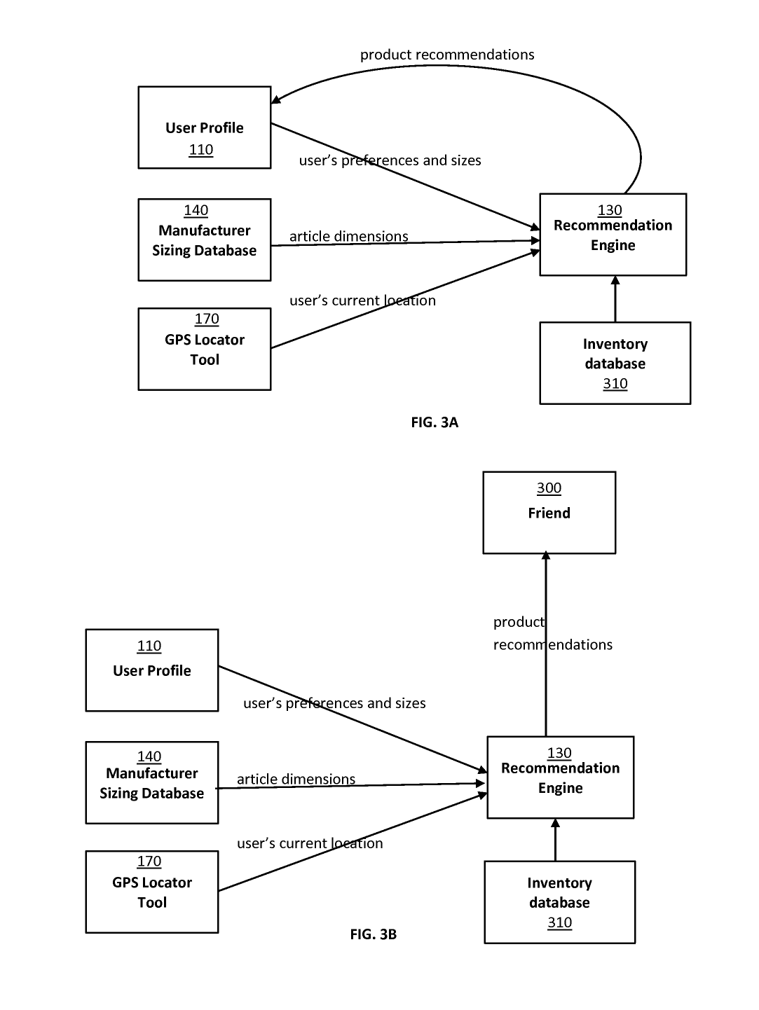

FIG. 3A illustrates a process whereby elements of an embodiment cooperate to make recommendations to a user. As shown, data from a user profile 110, a manufacturer sizing database 140, and optionally a GPS locator tool 170 may be communicated to a recommendation engine 130 which may apply an algorithm to the data to recommend specific products to a user contained in an inventory 310 database. FIG. 3B shows a similar process, but in this case the recommendation is being made to a friend 300 of the user with who appropriate data has been shared.

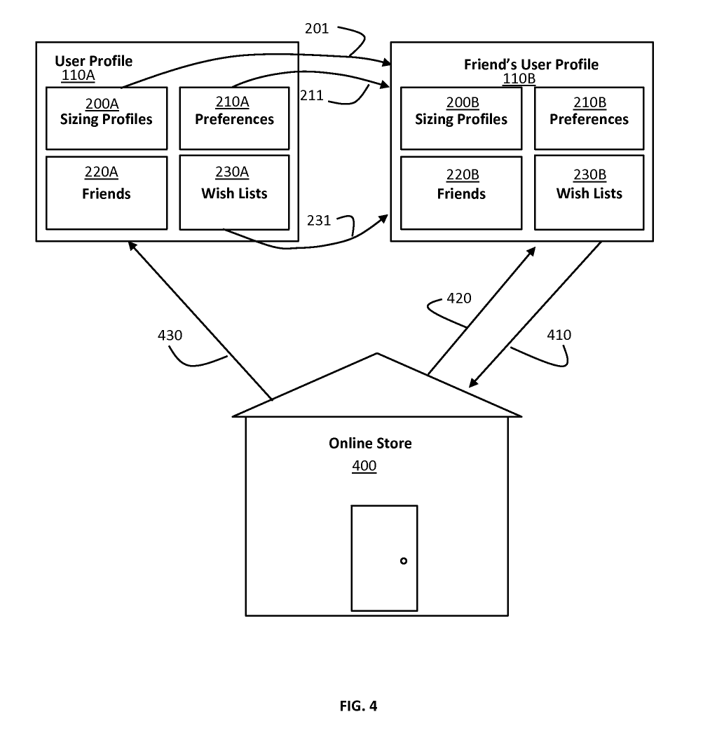

FIG. 4 illustrates data being shared by a user 110A with a friend 110B for the purpose of making a purchasing decision 410 in an online store 400. In this instance, the shared data includes sizing profiles 200A, preferences 210A, and wish lists 230A. However, embodiments may also allow the user 110A to share access to the preferences of its friends 220A provided the friends have authorized such sharing. This may allow, for instance, a mother buying for her daughter, to account for popular buy trends among her daughter's peers in addition to her daughter's stated preferences. Friend data shared in this way may or may not be stripped of personally identifying information, so that the viewer may learn of trends among a peer group without being able to attribute specific preferences to specific individuals. Once a purchase is made 410, the buyer 110B may have the product shipped to its location 420 or directly 430 to the user 110A.

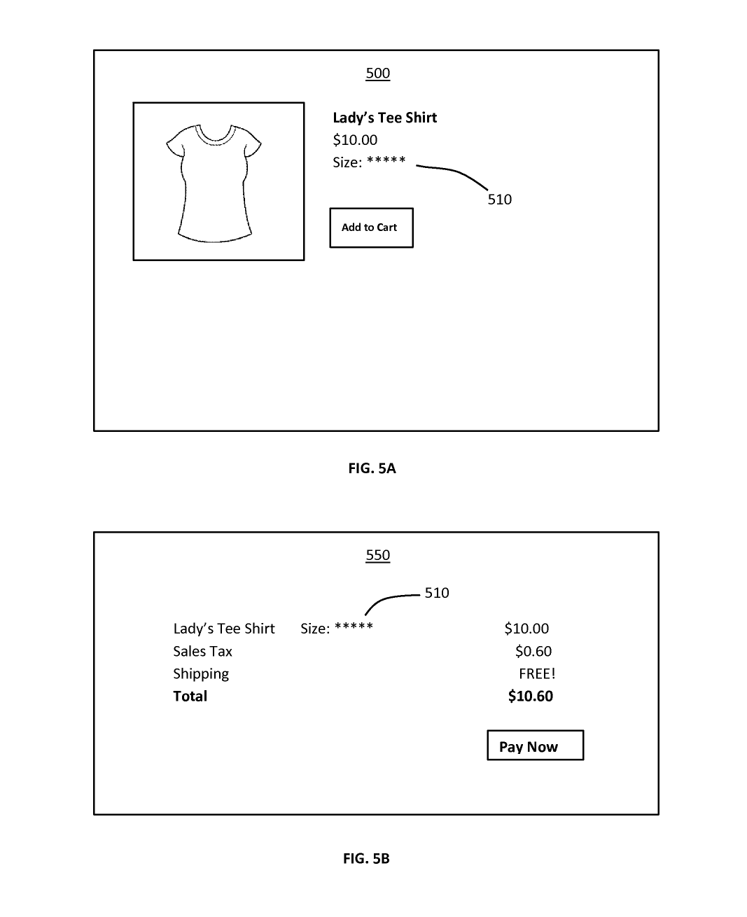

FIG. 5A illustrates how some data may be shared while being obscured from view. A typical ecommerce page 500 is shown with a lady's Tee Shirt for $10.00; however, the size 510 is obscured from view. FIG. 5 interprets this as a string of asterisks, but any other means for obscuring would also be appropriate such as by blurring or even not displaying the data at all. FIG. 5B shows the same article in an ecommerce shopping cart 550 with the size 510 obscured. Thus, a friend can purchase an appropriately sized product for a user without ever knowing the user's size.

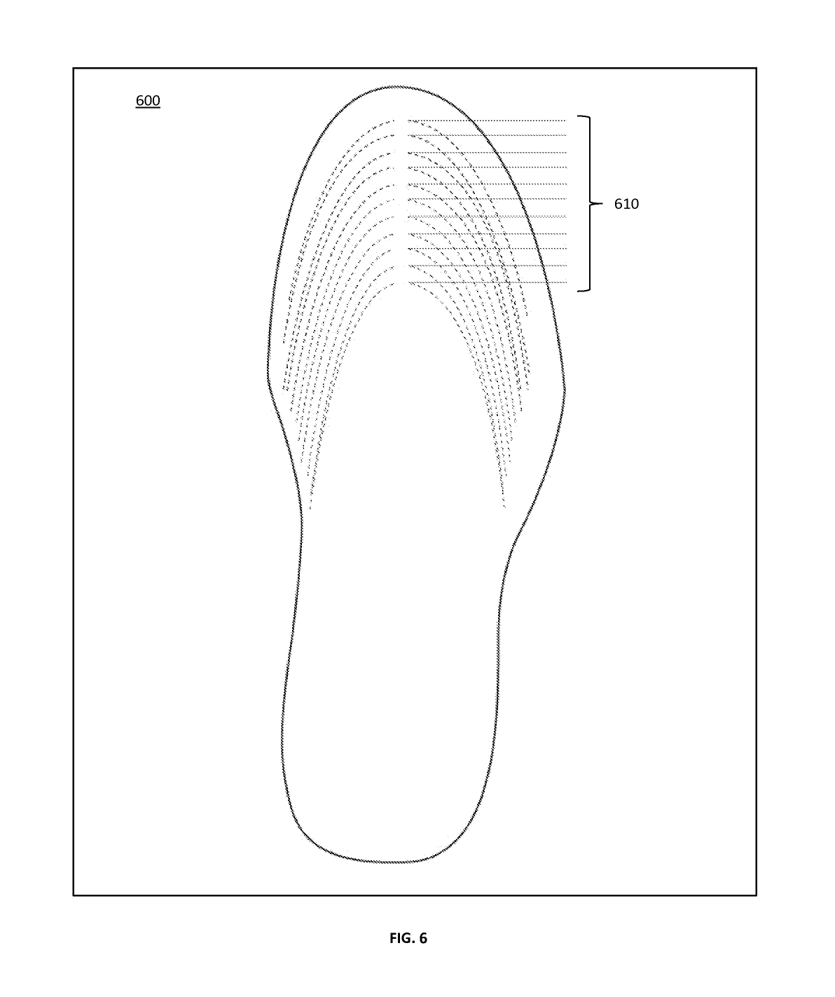

Embodiments may also include a database of printable sizing charts that a user may print out and compare to its body to determine appropriate article sizes. For instance FIG. 6 illustrates a 1:1 scale printable sizing chart 600 for a particular manufacturer's shoe line. The user would print out this chart 600 and determine his/her shoe size by placing his/her foot on the chart 600 and reading the scale 610.

It will be apparent to those skilled in the art that the above methods and apparatuses may be changed or modified without departing from the general scope of the invention. The invention is intended to include all such modifications and alterations insofar as they come within the scope of the appended claims or the equivalents thereof.

I/We claim:

1. A computer program for guiding the purchase of clothing articles, comprising:
a user profile comprising
(i) a data entry interface adapted to receive user preference data including clothing article sizing parameters, clothing article color preferences, and clothing article style preferences;
(ii) a sharing feature enabling a user to share user preference data with other user-selected users;
a manufacturer sizing database stored on a computer readable medium and containing clothing article dimensions; and
an article recommendation feature adapted to apply a recommendation algorithm to user preference data and to a plurality of purchase options to arrive at a set of articles recommended based at least on size, and one or more of color, style, or article type.

2. The computer program of claim 1, further comprising a manufacturer sizing chart database stored on a computer readable medium and containing two dimensional printable 1:1 scale images which may be compared to a portion of a user's body to select an appropriately sized article.

3. The computer program of claim 1, further comprising an auto fill tool adapted to read shared user preference data from a user profile of another to auto fill fields in an e-commerce website.

4. The computer program of claim 3, wherein the auto fill tool is further adapted to read shared user sizing data from a user profile of another into one or more fields of an e-commerce website while concealing the sizing data from view.

5. The computer program of claim 1, wherein articles recommended by the article recommendation feature are selected from one or more of clothing, jewelry, makeup, or shoes.

6. The computer program of claim 1, further comprising a GPS locator tool adapted to determine the location of a user's GPS enabled device and pass the location data to the article recommendation engine.

7. The computer program of claim 1, further comprising a tag scanning tool adapted to read photographic barcode data from a product tag, match the barcode data to a particular product, and add the product to a user's wish list.

8. A computer program for guiding the purchase of clothing articles, comprising:
a user profile comprising
(i) a data entry interface adapted to receive user preference data including clothing article sizing parameters, clothing article color preferences, and clothing article style preferences;
(ii) a sharing feature enabling a user to share user preference data with other user-selected users;
a manufacturer sizing database stored on a computer readable medium and containing clothing article dimensions; and
a manufacturer sizing chart database stored on a computer readable medium and containing two dimensional printable 1:1 scale images which may be compared to a portion of a user's body to select an appropriately sized article.

9. A computer program for guiding the purchase of clothing articles, comprising:
a user profile comprising
(i) a data entry interface adapted to receive user preference data including clothing article sizing parameters, clothing article color preferences, and clothing article style preferences;
(ii) a sharing feature enabling a user to share user preference data with other user-selected users;
a manufacturer sizing database stored on a computer readable medium and containing clothing article dimensions; and
an auto fill tool adapted to read shared user preference data from a user profile of another to auto fill fields in an e-commerce website.

10. The computer program of claim 6, wherein the auto fill tool is further adapted to read shared user sizing data from a user profile of another into one or more fields of an e-commerce website while concealing the sizing data from view.
